(19) United States
(12) Patent Application Publication
(10) Pub. No.: US 2008/0262882 A1
(43) Pub. Date: Oct. 23, 2008

(54) Providing and correlating clinical and business performance measures and benchmarks relating to medical treatment

(75) Inventor: Aidan Farrell, Kennett Square, PA (US)

Correspondence Address: ROPES & GRAY LLP, PATENT DOCKETING 39/361, 1211 AVENUE OF THE AMERICAS, NEW YORK, NY, 10036-8704, US

(73) Assignee: AstraZeneca AB, Sodertalje (SE)

(21) Appl. No.: 11/788,112

(22) Filed: Apr. 18, 2007

(51) Int. Cl. G06F 9/44

(52) U.S. Cl. 705/7

(57) ABSTRACT

Methods and systems for providing and correlating clinical and business performance measures and benchmarks for medical practitioners are provided. Clinical and business data is collected from a plurality of medical practitioners. The clinical data may pertain to one or more clinical metrics that relate to treatment offered to patients by medical practitioners. The business data may pertain to one or more business metrics that relate to commercial performance of the medical practitioners. Several benchmarking reports are prepared based on this data and provided to different medical practitioners showing them where they stand in comparison to other practitioners within their practice, specific or general discipline or industry.

### FIELD OF THE INVENTION

The present invention relates to performance benchmarks for measuring and comparing medical treatment, and particularly to systems and methods for providing and correlating clinical and business performance measures and benchmarks for medical practitioners in order to improve patient treatment and results.

### BACKGROUND OF THE INVENTION

Benchmarks are commonly used in many industries and areas to serve as standards against which practices or products may be compared. With respect to the healthcare industry, behavioral sciences research has shown that peer-to-peer benchmarking may improve performance on a number of tasks. For example, business measures and benchmarks have been provided for practitioners to compare themselves against their peers in terms of revenues, business volume, expenses and profits.

Similarly, clinical measures and benchmarks have been considered or adopted in order to, for example, reduce variation in patient treatment, enhance physician performance feedback, improve the effectiveness of medical care facilities, and develop an understanding of best practices.

It would be desirable, however, to combine both clinical and business performance measures and benchmarks and distribute them to healthcare providers to drive better patient treatment quality and results, thereby improving the quality of patient care.

While some correlation may or may not exist between clinical and business performance of a healthcare provider, correlation does not necessarily imply causation. However, strong correlational relationships may have predictive value and may be useful in driving better patient treatment. Therefore, it would be also desirable to correlate clinical performance with business performance to improve the quality of patient care.

### SUMMARY OF THE INVENTION

It is an object of the present invention to provide clinical and business performance measures and benchmarks and distribute them to healthcare providers to drive better patient treatment quality and results, thereby improving the quality of patient care.

It is also an object of the present invention to correlate clinical performance with business performance to improve the quality of patient care.

These and other objects of the present invention are accomplished by systems and methods for providing performance benchmarks for at least one medical practitioner, whereby clinical and business data may be collected from a plurality of medical practitioners and used to create benchmarking reports. The clinical data may pertain to one or more clinical metrics that relate to treatment offered to patients by the plurality of medical practitioners. The business data may pertain to one or more business metrics that relate to commercial performance of the plurality of medical practitioners. Several benchmarking reports may be prepared based on this data.

One or more benchmarking reports may be prepared to include a subset of the clinical data that was collected from the plurality of medical practitioners with respect to a particular clinical metric. Other benchmarking reports may be prepared to include a subset of the business data collected from the plurality of medical practitioners with respect to a particular business metric. Additional benchmarking reports may be prepared for the other metrics. The benchmarking reports may be provided to the different medical practitioners showing them where they stand in comparison to other practitioners within their practice, specific or general discipline or industry.

A system for providing such benchmarks may also be provided. The system comprises a server adapted to prepare the benchmarking reports, and a plurality of workstations that are coupled to the server. Each one of the plurality of workstations may be adapted to receive the clinical and business data, communicate them to the server, receive from the server the benchmarking reports and display them to the at least one medical practitioner. Each one of the medical practitioners may be given access to at least one of the plurality of workstations. The server may also be adapted to run a web-based program that allows the at least one medical practitioner to view clinical data and business data pertaining to that practitioner's practice. Similarly, a processor readable medium encoded with machine-readable instructions for providing the above performance benchmarks may also be provided.

The present invention may be applicable to all medical practices including, but not limited to, cardiology practices. The clinical metrics used in such practices may include use of Beta blocker therapy for treatment of patients suffering from Left Ventricular Systolic Dysfunction, for treatment of patients eligible for Implantable Cardioverter-Defibrillator, or for treatment of post-Myocardial Infarction patients. The clinical metrics may include use of Aspirin post-Myocardial Infarction, use of ACE inhibitor/ARB for Congestive Heart Failure, use of Warfarin for Atrial Fibrillation, use of Statins for Hypercholesterolemia, a plurality of measures specified in predetermined treatment guidelines, outcome measures, laboratory certifications items, or any combination of the same. The business metrics may include procedure volumes, encounters, E&M coding distribution, revenue, overhead, physician compensation structures, physician productivity, staffing, expenses, RVU production, account receivables, profit, or any combination of the same.

Clinical data collection comprises accessing patient health records pertaining to the plurality of medical practitioners. Patient charts pertaining to the plurality of medical practitioners may be identified based on classification codes associating patient treatment with diagnoses. A statistically valid randomization process may be used to select the charts to be reviewed. The charts identified as having clinical data pertaining to the clinical metrics may be reviewed. Chart review may include determining whether treatments relating to the clinical metrics were offered, recording instances in which the treatment was not offered due to one or more contraindications, and/or determining the amounts of medication offered to treat patients diagnosed with particular medical conditions relating to clinical metrics. The resulting clinical benchmarking reports may depict the level of compliance of each one of the plurality of medical practitioners and may distinguish instances in which treatment was not offered due to contraindications.

Business data collection comprises accessing accounting records pertaining to the plurality of medical practitioners, reviewing business records that are identified as having business data pertaining to the business metrics, and recording business data pertaining to the business metrics. The resulting business benchmarking reports may show each one of the plurality of medical practitioners where the practitioner stands with respect to the business metrics.

Correlations between the subset of clinical data in the first benchmarking report and the subset of business data in the second benchmarking report may be calculated and provided to the medical practitioners under certain conditions. For example, a calculated correlation may be provided if a substantially positive correlation is found between the subsets of clinical and business data. The practitioners may also be provided with suggestions to help improve their performances. Such suggestions may include a recommendation to change treatment strategies, a recommendation to implement different organizational strategies, recommendations to streamline business operations and improve human performance, a recommendation to collaborate with other medical practitioners to accelerate the speed at which changes occur, etc.

### BRIEF DESCRIPTION OF THE DRAWINGS

The above and other advantages of the invention will be more apparent upon consideration of the following detailed description, taken in conjunction with the accompanying drawings, in which like reference characters refer to like parts throughout, and in which:

FIG. 1 is a preferred flow diagram of a process that may be used to provide and correlate clinical and business performance measures and benchmarks in accordance with certain embodiments of the present invention;

FIG. 2 is a preferred flow diagram of a process that may be used to collect and disseminate clinical and business performance measures and benchmarks in accordance with certain embodiments of the present invention;

FIG. 3 is an exemplary clinical benchmark that may presented in accordance with certain embodiments of the present invention;

FIG. 4 is an exemplary business benchmark that may presented in accordance with certain embodiments of the present invention; and

FIG. 5 is a block diagram of an exemplary system that may be used to implement the processes and functions of certain embodiments of the present invention.

### DETAILED DESCRIPTION OF THE INVENTION

The present invention is directed to systems and methods for providing and correlating clinical and business performance measures and benchmarks for medical practitioners in order to improve patient treatment and results. This may be accomplished by collecting data from medical practices relating to patient treatment (such as medical regimen and counseling) and relating to business performance. This data may then be processed in order to create one or more benchmarks that may be utilized as bases for comparing treatment quality and profitability with peers. The benchmarks that may be created preferably include one or more clinical benchmarks pertaining to treatment quality and one or more business benchmarks pertaining to financial performance. These two kinds of benchmarks may be correlated in an effort to explore potential relationships between treatment quality and profitability. The processed data may be fed back to the medical providers who can measure their practice outcomes against peers to improve their own performance.

Such collection, processing and dissemination of data may be performed while remaining in compliance with all applicable laws and regulations, including but not limited to the Health Insurance Portability and Accountability Act of 1996 (“HIPAA”) and any privacy regulations promulgated thereunder (“HIPAA Privacy Regulations”), as well as applicable state privacy laws and regulations. The data may be collected, processed and disseminated on a regular basis (e.g., every few months, every year, every few years, etc.)

Although certain portions of the following discussion relate to collecting, processing and disseminating data in connection with cardiologists and cardiology practices, the principles of the present invention may be applicable to any type of healthcare provider or medical practice, or any other medical or other discipline.

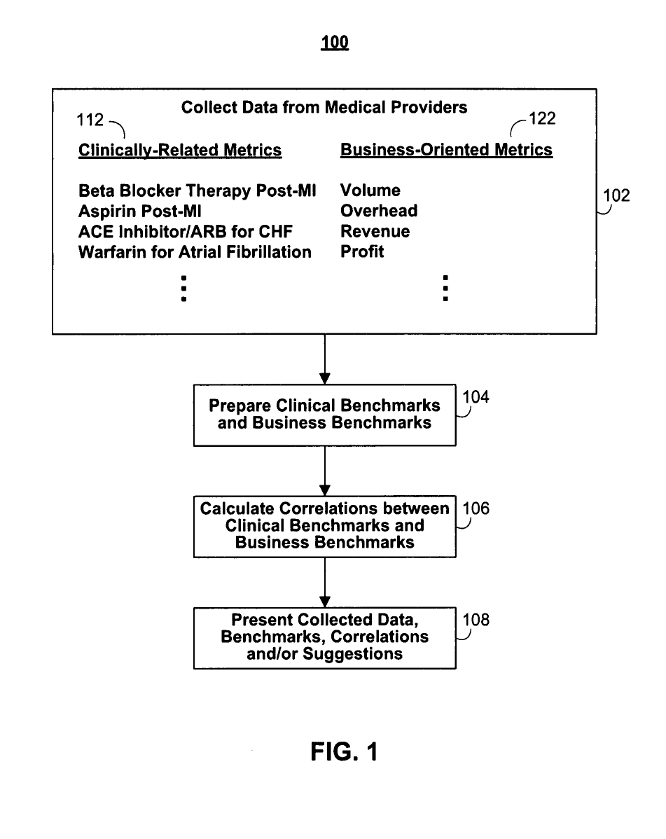

FIG. 1 describes a process 100 that can be used in accordance with certain embodiments of the present invention to provide and correlate clinical and business performance measures and benchmarks. At step 102 of process 100, specific data may be collected from medical providers such as cardiologists and cardiology practices. Such data may include clinically-related metrics 112, business-oriented metrics 122, and/or other factors (not shown). This data may be collected for each practice group and each physician within each group.

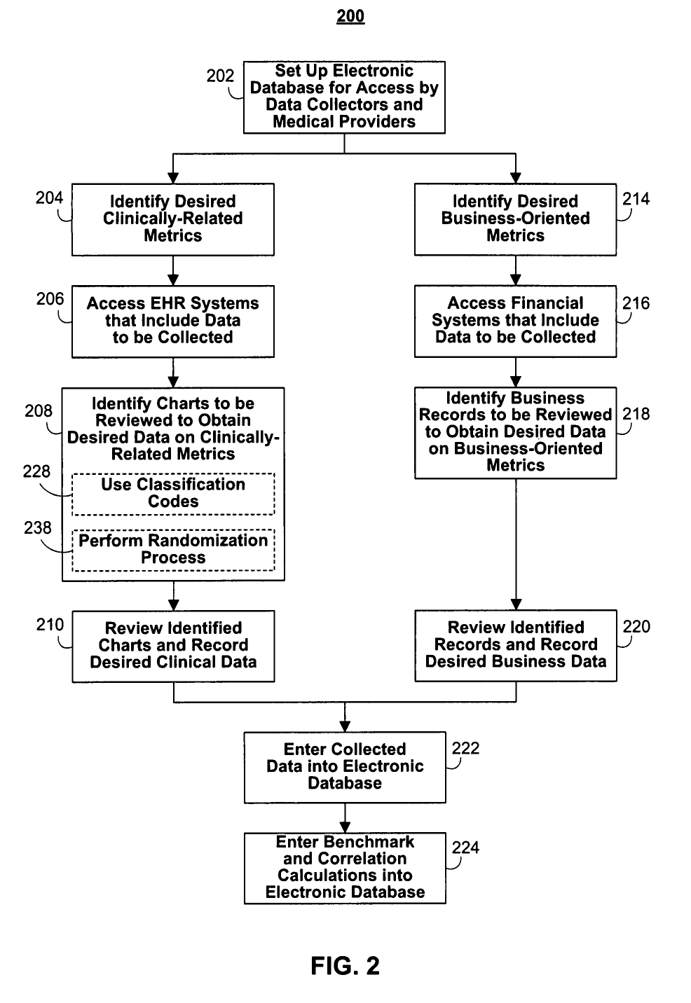

FIG. 2 describes a process 200 that can be used in accordance with certain embodiments of the present invention to collect and disseminate clinical and business performance measures and benchmarks. Process 200 relates to a preferred framework for performing the steps of collecting data from medical providers (step 102 of FIG. 1) and presenting the results to different practices (step 108 of FIG. 1).

At step 202 of FIG. 2, an electronic database may be set up. The electronic database may later be populated with data that is collected and generated. The electronic database may be accessed by data collectors (such as employees of the targeted medical practices, benchmark providers or outside vendors such as third party contractors), and by various medical practices (such as physicians and other employees of the targeted medical practices). Access to the electronic database may or may not be provided to other medical practices from which data was not collected. Steps 204-210 relate to preferred embodiments for collecting clinical data from medical practices while steps 214-220 relate to preferred embodiments for collecting business data from those practices.

At step 204, the desired clinically-related metrics may be identified. Clinically-related metrics may include medications offered to treat patients diagnosed with specific medical conditions, and measures thereof. As shown in FIG. 1, clinically-related metrics for cardiology practices may include medications offered to treat different conditions and diseases such as treatments related to blood pressure, lipid profiles, symptom and activity assessment, smoking, antiplatelet therapy, drug therapy for lowering cholesterol, myocardial Infarction (MI) therapy, any other measure listed in the 2007 Physician Quality Reporting Initiative (PQRI) Quality Measures, and/or any performance measure specified in treatment guidelines such as the ones provided by the American College for Cardiology (ACC), the American Heart Association (AHA) and/or any other appropriate organization.

For example, clinically-related cardiology metrics may be any number of core or additional metrics and may include use of Beta blocker for Left Ventricular Systolic Dysfunction (LVSD), for patients eligible for Implantable Cardioverter-Defibrillator (ICD), or post-MI. These metrics may also include Aspirin post-MI, ACE inhibitor/ARB for Congestive Heart Failure (CHF), Warfarin for Atrial Fibrillation, Statins for Hypercholesterolemia or Hyperlipidemia, any factor relating to patient treatment, or any combination of the same.

Clinically-related metrics may also include items in-line with non-invasive laboratory certifications. Laboratory certifications may be certifications provided to laboratories by accrediting bodies in order to confirm that the laboratories possess the qualifications necessary to conduct various measures and tests. Examples of such accrediting bodies are the ICANL, the ICAVL and the ICAEL. The ICANL is dedicated to promoting quality nuclear cardiology and nuclear medicine diagnostic evaluations in the delivery of healthcare by providing a peer review process of laboratory accreditation. The ICAVL is dedicated to promoting high quality noninvasive vascular diagnostic testing in the delivery of healthcare by providing a peer review process of laboratory accreditation. The ICAEL is dedicated to promoting high quality echocardiographic diagnostic evaluations in the delivery of healthcare by providing a peer review process of laboratory accreditation. Accordingly, clinically-related metrics may include items in-line with ICANL, ICAVL and ICAEL certifications.

Clinically-related metrics may also include certain outcome measures assessing medical effects or results of treatment for a particular disease or condition. Such outcome measures may include restoration of functional status, weight loss, decrease in blood pressure, etc. Other outcome measures, such as ones assessing economic or humanistic effects or results of treatment, may be used as bases for creating benchmarks other than the clinical and business benchmarks, as discussed further below.

At step 206 of FIG. 2, unstructured Electronic Health Records (EHR) systems may be accessed to collect the desired clinical data. Such systems include Allscripts, NextGen, GEMMS, GE Centricity, Misys, Athena, AcerMed, Epic, Alteer, etc. and may contain medical charts for patients treated by the targeted medical practices. Alternatively, paper medical charts may be accessed and identified as having relevant clinical data.

At step 208, the medical charts of some or all patients that will be reviewed to obtain the desired clinical data may be identified for each targeted practice. In certain preferred embodiments of the present invention, such a determination may be made based on widely recognized and utilized classification codes at step 228. An example of such a code is the International Classification of Diseases, Ninth Revision (ICD-9). More specifically, patient charts containing ICD-9 codes associated with patient diagnosis and treatment related to the desired clinical metrics are identified as charts to be potentially reviewed. In addition, or as an alternative, medication and disease lists or guidelines, as well as one or more other classification systems or filtering techniques associating patient treatment with diagnosed conditions, may be used.

In certain embodiments of the present invention, all charts identified as including data pertaining to the desired clinical metrics may be reviewed. In certain situations where reviewing all such charts would be overly time-consuming, costly or otherwise difficult, a statistically valid randomization process, or other appropriate method, may be used to select the charts for review at step 238. For clarity, steps 228 and 238 are represented in dotted lines to indicate that they are steps that may be implemented under certain circumstances. In alternative embodiments of the present invention, all charts for all patients of a targeted practice may be selected for review.

At step 210, data collectors (who may be employees of the targeted medical practices, benchmark providers or outside vendors such as third party contractors) and/or auditors may review the identified charts to collect, record and/or inspect the desired clinical data. More specifically, the identified charts may be reviewed to determine whether the treatments associated with the clinically-related metrics were offered, and/or determine the amounts of medication offered to treat specific conditions or diseases.

It should be noted that when clinical data is collected, instances in which specific treatments were not prescribed due to contraindications may be recorded as well. A contraindication is a situation in which prescribing a particular treatment might be harmful to a patient's health or well being and, therefore, should not be implemented. In other words, there may be situations in which a physician would otherwise treat a particular patient in compliance with proper treatment guidelines, but has chosen not to do so in order to minimize the possibility of harming the patient. Such a physician should not be penalized for not having treated the patient in a manner that would place the patient at risk. Accordingly, contraindications are preferably recorded during data collection in accordance with certain embodiments of the present invention.

Similarly, the desired business-oriented metrics may be identified at step 214. Business-oriented metrics may relate to the commercial performance resulting from the medical services performed by the healthcare provider(s) in a medical practice. As shown in FIG. 1, business-oriented metrics for any practice may include procedure volumes, encounters, E&M coding distribution, revenue, overhead, physician compensation structures, physician productivity, staffing, expenses, RVU production, account receivables, profit, any factor relating to financial performance, or any combination of the same.

At step 216 of FIG. 2, the targeted practices' accounting and book-keeping records may be accessed to collect the desired business data. Access to such records may be given by electronic means or through any other means. Medical practices may give data collectors on-location access to such records or may provide them directly to the benchmark providers on a regular basis. At step 218, the business records of interest may be identified for each targeted practice. At step 220, data collectors (who may be employees of the targeted medical practices, benchmark providers or outside vendors such as third party contractors) and/or auditors may review the identified records to collect, record and/or inspect the desired business data pertaining to the business-oriented metrics.

Summary reports on the data pertaining to the clinical and business metrics may be prepared and reported in any suitable format such as spreadsheets, or using web-based programs such that each practice represented in the data would be able to access its own data. Both clinical and business data may be reported in an individual practice and/or total practice summary format. For example, at step 222, the collected clinical and business data may be entered into the electronic database that is accessible by the targeted practices and the benchmark providers. The electronic database may be implemented in conjunction with a remotely-accessible program (such as a web-based program). Such a program may be a graphical representation program that allows each practice to view and be presented with its own data in graphical format, as described in conjunction with step 108 of FIG. 1.

Similarly, the prepared benchmarks and calculated correlations described below may also be entered into the electronic database at step 224 of FIG. 2. This enables each targeted practice, and/or other practices, to view such benchmarks and/or correlation calculations as described in conjunction with step 108 of FIG. 1. The practices or physicians having access to the electronic database may thus compare themselves against an entire group of practices or physicians on all metrics. Each practice and/or metric may be associated with a unique identifier making such an arrangement possible. Data may be collected from different medical practices across different disciplines and each practice within a discipline may be able to view its own data, as well as subsequently prepared benchmarks and/or correlation calculations, with respect to the particular discipline under which the practice falls.

Referring back to process 100 of FIG. 1, after the data pertaining to clinically-related metrics 112 and business-oriented metrics 122 is collected at step 102, benchmarks may be prepared at step 104 for these and other factors (not shown). For example, other factors may include outcome measures assessing economic or humanistic effects or results of treatment for a particular disease or condition.

Humanistic effects may refer to effects of treatment on patient quality of life based on assessments by the patient, the patient's family or caregivers, or the healthcare provider. They may also include patient satisfaction with care as provided by the various stakeholders in the healthcare system. Such outcome measures may include measures of mortality, morbidity, cost, quality of life, patient satisfaction, and others. Other measures may relate to the use of disease management and regimen adherence programs, clinical quality assurance programs, benchmarking at discrete units of analysis, measuring the use of evidence-based medicine practices, etc. Benchmarks other than the clinical and business benchmarks may be created based on such factors.

For example, satisfaction measures may be used to create a satisfaction benchmark. Satisfaction measures may be aimed at measuring patient satisfaction, or aimed at measuring satisfaction beyond the patient level, such as the satisfaction of a referring physician or employees. Data pertaining to these and other measures may be collected through the distribution and collection of surveys that gauge the responses and follow-ups to the distributed benchmarks. These surveys may measure patient reactions, administrator reactions, and/or physician reactions. For example, these surveys may include questions targeted to what was done (such as practice changes) in response to the received measures and benchmarks. Particular data that is collected and disseminated may be removed, replaced or changed as time passes based on relevance, usefulness, or for any other suitable purpose or reason.

The present invention is aimed in part at translating the collected data into materials that can be utilized by medical providers to improve their clinical and business practices. The collected data is accordingly processed and fed back in the form of quality and efficiency reports to the medical providers who, in turn, may measure their practice outcomes against peers to improve the quality of care and performance. More specifically, at step 104 of FIG. 1, the clinical and business benchmarks may be prepared from the data collected at step 102, taking contraindications into account.

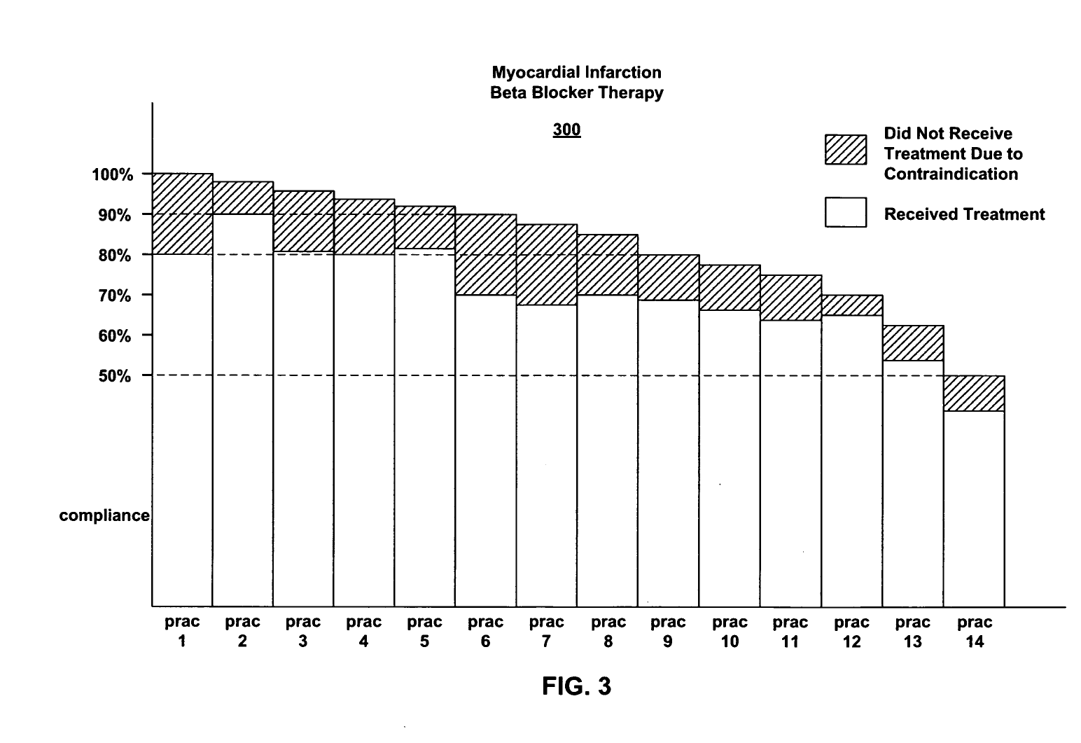

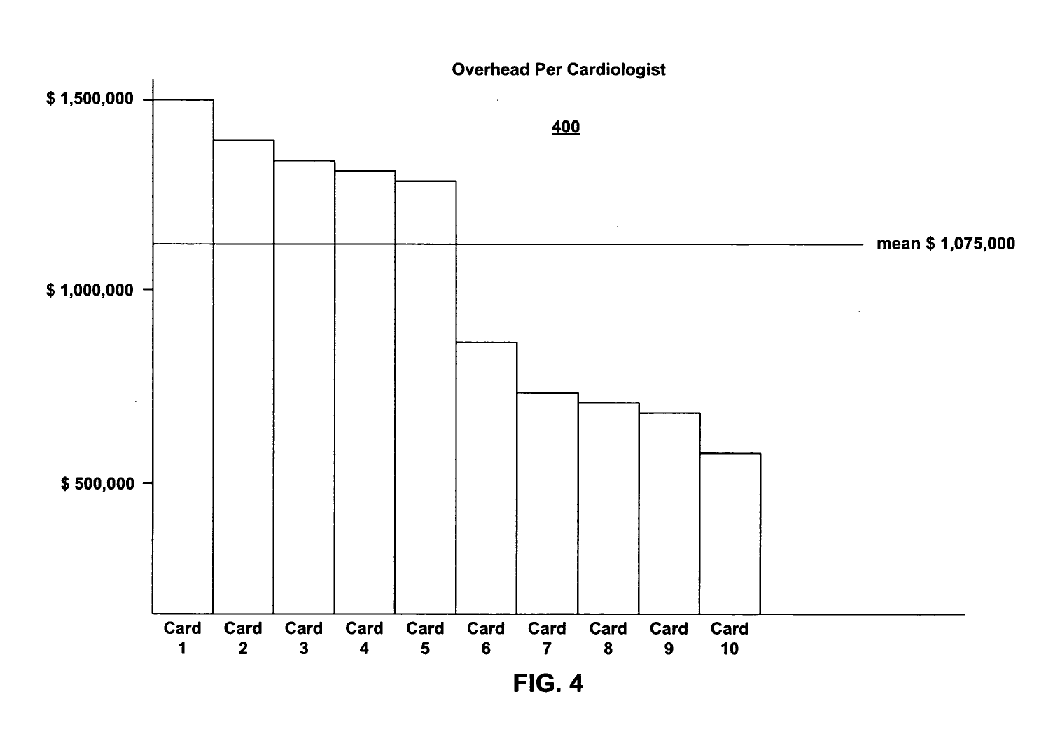

The present invention is also aimed in part at identifying relationships between clinical performance and business performance. Accordingly, the correlations between different clinical benchmarks (or all clinical benchmarks) and different business benchmarks (or all business benchmarks) may be calculated at step 106. More specifically, correlations between the collected clinically-related data and the collected business-oriented data may be calculated. At step 108, the prepared clinical and business benchmarks may be presented to the targeted practices and other practices. These benchmarks may be presented in the form of reports such as the ones shown in FIGS. 3 and 4. The collected clinical and business data may also be presented as part of the benchmarks or separately therefrom at step 108 of FIG. 1. Moreover, depending on the calculated correlations, the correlations may also be presented to certain targeted practices at step 108 as described in more detail below.

At step 108, the recipients of the performance measures, benchmarks and/or clinical/business correlation calculations may also be provided with suggestions that can help them improve their performance. Such suggestions may include changing treatment strategies, implementing new and innovative organizational strategies, streamlining business operations, improving human performance, etc.

Providers may also be advised to collaborate with each other to accelerate the speed at which those changes occur. For example, they may be encouraged to form one or more group sessions. These sessions may also include smaller breakout sessions based on clinical and/or business performance. For example, recipients exhibiting relatively similar performance or generally low performance may discuss and present on what they believe to be the cause of their successes and/or failures. They may identify, or be helped to identify, opportunities for improvement. Subsequent presentations by low-performing groups may provide an opportunity for them to discuss what operational and clinical changes were made in response to the report cards or other received materials, and to show how that has impacted their performance.

While correlation does not necessarily imply causation, it may very well be that certain efficient medical practices that are performing well financially happen to be providing high-quality treatment to their patients. Similarly, it is possible that failing or poor medical practices happen to provide low-quality patient treatment. Assuming that such a positive correlation exists, it may be possible to motivate practices that are performing poorly (both in financial terms and quality of treatment) by making them aware of this correlation in order to drive better patient treatment and performance. Accordingly, the materials that may be provided to physicians, medical practices and/or medical facilities may also include correlation calculations between the clinical and business benchmarks.

More specifically, if a strong positive correlation exists, the report cards or other materials provided to specific recipients who exhibit poor financial performance as well as poor quality of treatment may include correlation calculations between the clinical and business benchmarks. Similarly, such correlation calculations may also be provided to recipients who exhibit strong financial and quality of treatment performance.

Depending on the correlational relationship, such calculations may or may not be provided to recipients who exhibit strong financial performance and poor quality of treatment, recipients who exhibit poor financial performance and strong quality of treatment, or other recipients. For example, if a negative correlation is found, the correlation calculation is not provided to any recipient so as not to encourage better financial performance at the expense of patient treatment.

All materials presented to the practices at step 108 of FIG. 1 may be presented in the form of quality and efficiency report cards specifically tailored to each physician (including primary care and referring physicians), medical practices and/or medical facilities. Such report cards may be physical documents, electronic documents or web content (as described in connection with the electronic database of FIG. 2), or may have any other suitable form. These report cards may include measures of the particular recipients' clinical and business performance, as well as clinical and business benchmarks. This enables the recipients to gauge their performance and see where they stand in comparison to their peers within the same practice or within the entire discipline or even industry. These and other materials may help medical providers and organizations identify areas where problems exist, areas in which performance needs to be improved, and how performance is changing over time.

Software may also be provided for receiving clinical and business data, preparing benchmarks based on the data, calculating correlations between such benchmarks and making recommendations based on the above. Such software may be downloaded or may be stored on a processor readable medium that may be encoded with machine-readable instructions for performing the above steps.

FIGS. 3 and 4 show exemplary benchmarks that may be provided to different practices and physicians as part of the report cards discussed above. According to preferred embodiments of the present invention, such benchmarks may be visual representations in the form of graphs, each one pertaining to a particular metric across an entire discipline or specific practice. For example, FIG. 3 shows a clinical benchmark 300 for treatment of post-MI patients with Beta blocker therapy for all cardiology practices whose data was collected. In graph 300, the degree of compliance with the suggested guidelines, such as those of the ACC or AHA, is shown for each practice in percentage terms. In this example, for purposes of illustration, 14 cardiology practices are depicted in decreasing order of compliance. For example, while cardiology practice 1 is fully compliant, practice 6 is 90% compliant, practice 9 is 80% compliant, and practice 14 is only 50% compliant.

Through such a graph 300, all 14 practices can gauge their performance in comparison to each other with respect to post-MI Beta blocker treatment. Similarly, other graphs may be provided for each of the metrics for which data was collected. Treatment compliance in several or all metrics may be combined and shown in a single graph. According to other preferred embodiments of the present invention, a graph may be distributed to each practice showing each physicians' compliance across a single practice or medical facility. In illustrating each practice's compliance, graph 300 also takes into account and distinguishes contraindications so as not to present potentially misleading information. Alternatively, situations in which contraindications exist may be omitted altogether from the benchmark preparation and depiction.

As such, clinical performance benchmarks may be provided to show cardiologists where they stand in comparison to other cardiologists in terms of compliance with accepted treatment guidelines such as those provided by the ACC and/or the AHA. Similarly, clinical performance benchmarks may be provided for any medical practitioners within any other medical field, in order to show them where they stand in comparison to others in terms of compliance with treatment guidelines pertaining to that field. Alternatively, clinical performance benchmarks may be provided for a group of medical practitioners selected based on any other criteria, in order to show them where they stand in comparison to others in terms of compliance with relevant treatment guidelines.

FIG. 4 shows a business benchmark 400 for the overhead spent per cardiologist in a group of 10 cardiologists. The 10 cardiologists may be all cardiologists that belong to a single cardiology practice or may be chosen based on a common or different location, type of practice, experience, etc. In this example, for purposes of illustration, the 10 cardiology practices are depicted in decreasing amounts of overhead, with a mean overhead calculated to be $1,075,000 per cardiologist.

The order or manner in which the benchmarks of FIGS. 3 and 4 are depicted are for illustration purposes only and any visual presentation or other method can be used to depict a benchmark conveying information enabling practices and physicians to gauge their performance relative to each other using the data that is collected from them. For example, the practices or physicians could be ordered alphabetically. Their degree of compliance can be shown in terms of percentiles (e.g., values on the scale of 100, each one associated with a practice and indicating the percent of a distribution that is equal to or below it). Alternatively, their degree of compliance could be shown in terms of measured data (e.g., number of patients treated in manner that is compliant), thereby conveying both the data collected for a particular metric and the benchmark prepared for that metric in a single image. Alternatively, the benchmarks may be depicted through other types of charts (e.g., a pie chart) or through non-graphical means (e.g., written data).

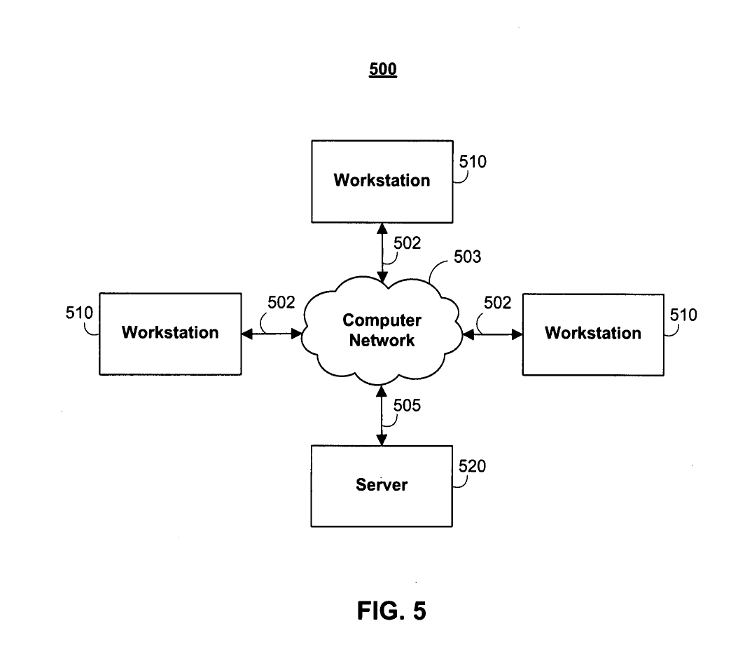

Referring to FIG. 5, exemplary system 500 for implementing the present invention is shown. As illustrated, system 500 may include one or more workstations 510. Workstations 510 may be local or remote, and are connected by one or more communications links 502 to computer network 503 that is linked via communications link 505 to server 520.

Server 520 may be any suitable server, processor, computer, data processing device, or combination of the same. Benchmark providers may have access to server 520 which may be used to implement certain steps of processes 100 and/or 200 of FIGS. 1 and 2. More specifically, server 520 may store and maintain the electronic database described in step 202 of FIG. 2, run the remotely-accessible program also described in conjunction with FIG. 2, and/or run the software described above that is capable of preparing benchmarks. Server 520 may also be used to store the data that is collected from medical practices at step 102 of FIG. 1, prepare the benchmarks of step 104, perform the correlation calculations of step 106, and communicate the collected data, prepared benchmarks and calculated correlations to one or more workstations 510. Server 520 may run a program (such as the web-based program described above) that allows the medical practitioner to view clinically-related data and business-oriented data pertaining to the practitioner's practice.

Computer network 503 preferably includes the Internet but may consist of any suitable computer network such as an intranet, a wide-area network (WAN), a local-area network (LAN), a wireless network, a digital subscriber line (DSL) network, a frame relay network, an asynchronous transfer mode (ATM) network, a virtual private network (VPN), or any combination of the same. Communications links 502 and 505 may be any communications links suitable for communicating data between workstations 510 and server 520, such as network links, dial-up links, wireless links, hard-wired links, etc. The data collected at step 102 of FIG. 1 (e.g., the summary reports described above) as well as the benchmarks and correlations prepared and calculated at steps 104 and 106 of FIG. 1, respectively, may be communicated over communications links 502 and 505.

Workstations 510 may be personal computers, laptop computers, mainframe computers, dumb terminals, data displays, Internet browsers, Personal Digital Assistants (PDAs), two-way pagers, wireless terminals, portable telephones, etc., or any combination of the same. Each practice that is targeted for data collection and/or benchmarking may be outfitted on-site with one or more workstations 510, or may otherwise be given access to one or more workstations 510. A workstation 510 may for example be used to access patient health records and accounting records pertaining to the particular practice having access to the workstation.

Workstations 510 may be used by data collectors (such as employees of the targeted medical practices, benchmark providers or outside vendors such as third party contractors) to enter the data that is collected at step 102 of FIG. 1 and communicate it to server 520 so that it may be entered into the electronic database as per step 222 of FIG. 2. Workstations 510 may be used by various medical practices (such as physicians and other employees of the targeted medical practices) to view the data that is collected at step 102 of FIG. 1, as well as the benchmarks and correlations that are prepared and calculated at steps 104 and 106 of FIG. 1, respectively, and communicated to the workstations from server 520. Clinical and business benchmarks such as the ones shown in FIGS. 3 and 4 may be displayed on workstations 510 such that each practice represented in the data would be able to access its own data.

One of ordinary skill in the art should appreciate that the present invention may be practiced in embodiments other than those described herein. For example, it will be understood that the size, shape, arrangement, and label of various portions of the benchmarks discussed or shown are examples shown for purposes of illustration only. It will be understood that modifications of any or all of the foregoing characteristics of these portions are within the scope of the invention.

It will be understood that the foregoing is only illustrative of the principles of the present invention, and that various modifications can be made by those skilled in the art without departing from the scope and spirit of the invention, and the invention is limited only by the claims that follow.

What is claimed is:

1. A method for providing performance benchmarks for at least one medical practitioner, the method comprising:
collecting clinical data from a plurality of medical practitioners, the clinical data pertaining to at least one clinical metric that relates to treatment offered to patients by the plurality of medical practitioners;
collecting business data from the plurality of medical practitioners, the business data pertaining to at least one business metric that relates to commercial performance of the plurality of medical practitioners;
preparing a plurality of benchmarking reports, the plurality of benchmarking reports comprising:
a first benchmarking report including a subset of the clinical data collected from the plurality of medical practitioners with respect to the at least one clinical metric, and
a second benchmarking report including a subset of the business data collected from the plurality of medical practitioners with respect to the at least one business metric, and
providing the first and second benchmarking reports to the at least one medical practitioner.

2. The method of claim 1 wherein the at least one clinical metric comprises use of Beta blocker therapy for treatment of patients suffering from Left Ventricular Systolic Dysfunction, for treatment of patients eligible for Implantable Cardioverter-Defibrillator, or for treatment of post-Myocardial Infarction patients.

3. The method of claim 1 wherein the at least one clinical metric comprises a metric that is selected from the group consisting of use of Aspirin post-Myocardial Infarction, use of ACE inhibitor/ARB for Congestive Heart Failure, use of Warfarin for Atrial Fibrillation, and use of Statins for Hypercholesterolemia.

4. The method of claim 1 wherein the at least one clinical metric comprises a plurality of measures specified in predetermined treatment guidelines.

5. The method of claim 1 wherein the at least one clinical metric comprises outcome measures or laboratory certifications items.

6. The method of claim 1 wherein the at least one business metric comprises a metric that is selected from the group consisting of procedure volumes, encounters, E&M coding distribution, revenue, overhead, physician compensation structures, physician productivity, staffing, expenses, RVU production, account receivables, and profit.

7. The method of claim 1 wherein the collecting the clinical data comprises accessing patient health records pertaining to the plurality of medical practitioners.

8. The method of claim 1 wherein the collecting the clinical data comprises identifying patient charts pertaining to the plurality of medical practitioners based on a plurality of classification codes associating patient treatment with diagnoses.

9. The method of claim 1 wherein the identifying the patient charts comprises using a statistically valid randomization process to select the charts for reviewing.

10. The method of claim 1 wherein the collecting the clinical data comprises reviewing patient charts that are identified as having clinical data pertaining to the at least one clinical metric.

11. The method of claim 10 wherein the reviewing the patient charts comprises determining whether a treatment relating to the at least one clinical metric was offered.

12. The method of claim 11 wherein the reviewing the clinical data comprises recording an instance in which the treatment was not offered due to one or more contraindications.

13. The method of claim 10 wherein the reviewing the patient charts comprises determining an amount of medication offered to treat a patient diagnosed with a particular medical condition relating to the at least one clinical metric.

14. The method of claim 1 wherein the collecting the business data comprises:
accessing accounting records pertaining to the plurality of medical practitioners;
reviewing business records that are identified as having business data pertaining to the at least one business metric; and
recording business data pertaining to the at least one business metric.

15. The method of claim 1 wherein at least one of the first and second benchmarking reports depicts a level of compliance of each one of the plurality of medical practitioners.

16. The method of claim 1 wherein the first benchmarking report distinguishes instances in which treatment was not offered due to one or more contraindications.

17. The method of claim 1 wherein at least one of the first and second benchmarking reports shows the at least one medical practitioner where the practitioner stands in comparison to the plurality of medical practitioners.

18. The method of claim 1 wherein at least one of the first and second benchmarking reports shows the at least one medical practitioner where the practitioner stands in comparison to a plurality of medical practitioners within the practitioner's medical practice.

19. The method of claim 1 further comprising:
collecting data related to additional factors from the plurality of medical practitioners;
preparing at least one other benchmarking report including a subset of the data collected from the plurality of medical practitioners with respect to the additional factors; and
providing the at least one other benchmarking report to the at least one medical practitioner.

20. The method of claim 19 wherein the additional factors comprise outcome measures assessing economic or humanistic results of treatment for a particular disease or condition.

21. The method of claim 19 wherein the additional factors comprise measures that are selected from the group consisting of satisfaction measures, use of disease management and regimen adherence programs, clinical quality assurance programs, benchmarking at discrete units of analysis, and use of evidence-based medicine practices.

22. The method of claim 19 wherein the additional factors comprise measures obtained through distributing and collecting surveys that gauge responses to the first and second benchmarking reports.

23. The method of claim 1 further comprising calculating a correlation between the subset of clinical data in the first benchmarking report and the subset of business data in the second benchmarking report.

24. The method of claim 23 further comprising providing the calculated correlation to the at least one medical practitioner under certain conditions.

25. The method of claim 23 further comprising providing the calculated correlation to the at least one medical practitioner if a substantially positive correlation is found between the subsets of clinical and business data.

26. The method of claim 1 further comprising providing the at least one medical practitioner with at least one suggestion to improve the practitioner's performance.

27. The method of claim 26 wherein the at least one suggestion comprises a suggestion that is selected from the group consisting of a recommendation to change treatment strategies, a recommendation to implement different organizational strategies, recommendations to streamline business operations and improve human performance, and a recommendation to collaborate with other medical practitioners to accelerate the speed at which changes occur.

28. A system for providing performance benchmarks for at least one medical practitioner, the system comprising:
a server adapted to prepare a plurality of benchmarking reports, the plurality of benchmarking reports comprising:
a first benchmarking report including a subset of clinical data collected from a plurality of medical practitioners with respect to at least one clinical metric that relates to treatment offered to patients by the plurality of medical practitioners, and
a second benchmarking report including a subset of business data collected from the plurality of medical practitioners with respect to at least one business metric that relates to commercial performance of the plurality of medical practitioners, and
a plurality of workstations that are coupled to the server, each of the plurality of workstations being adapted to:
receive clinical and business data and communicate them to the server,
receive from the server the first and second benchmarking reports and
display the first and second benchmarking reports to the at least one medical practitioner.

29. The system of claim 28 wherein each one of the plurality of medical practitioners is given access to at least one of the plurality of workstations.

30. The system of claim 28 wherein the server is further adapted to run a web-based program that allows the at least one medical practitioner to view clinical data and business data pertaining to the practitioner's practice.

31. The system of claim 28 wherein the server is further adapted to store an electronic database in which the collected data and prepared benchmarking reports are stored.

32. The system of claim 28 wherein at least one of the plurality of workstations is further adapted to access patient health records and accounting records pertaining to at least one of the plurality of medical practitioners.

33. The system of claim 28 wherein the at least one clinical metric comprises use of Beta blocker therapy for treatment of patients suffering from Left Ventricular Systolic Dysfunction, for treatment of patients eligible for Implantable Cardioverter-Defibrillator, or for treatment of post-Myocardial Infarction patients.

34. The system of claim 28 wherein the at least one clinical metric comprises a metric that is selected from the group consisting of use of Aspirin post-Myocardial Infarction, use of ACE inhibitor/ARB for Congestive Heart Failure, use of Warfarin for Atrial Fibrillation, and use of Statins for Hypercholesterolemia.

35. The system of claim 28 wherein the at least one clinical metric comprises a plurality of measures specified in predetermined treatment guidelines.

36. The system of claim 28 wherein the at least one clinical metric comprises outcome measures or laboratory certifications items.

37. The system of claim 28 wherein the at least one business metric comprises a metric that is selected from the group consisting of procedure volumes, encounters, E&M coding distribution, revenue, overhead, physician compensation structures, physician productivity, staffing, expenses, RVU production, account receivables, and profit.

38. The system of claim 28 wherein at least one of the first and second benchmarking reports comprises a graph depicting a level of compliance of each one of the plurality of medical practitioners.

39. The system of claim 28 wherein the first benchmarking report distinguishes instances in which treatment was not offered due to one or more contraindications.

40. The system of claim 28 wherein at least one of the first and second benchmarking reports shows the at least one medical practitioner where the practitioner stands in comparison to the plurality of medical practitioners.

41. The system of claim 28 wherein at least one of the first and second benchmarking reports shows the at least one medical practitioner where the practitioner stands in comparison to a plurality of medical practitioners within the practitioner's medical practice.

42. The system of claim 28 wherein at least one of the plurality of workstations is further adapted to display a correlation calculated between the subset of clinical data in the first benchmarking report and the subset of business data in the second benchmarking report.

43. The system of claim 42 wherein the at least one of the plurality of workstations displays the calculated correlation if a substantially positive correlation is found between the subsets of clinical and business data.

44. The system of claim 28 wherein at least one of the plurality of workstations is further adapted to display at least one suggestion to improve the practitioner's performance.

45. The system of claim 44 wherein the at least one suggestion comprises a suggestion that is selected from the group consisting of a recommendation to change treatment strategies, a recommendation to implement different organizational strategies, recommendations to streamline business operations and improve human performance, and a recommendation to collaborate with other medical practitioners to accelerate the speed at which changes occur.

46. A processor readable medium encoded with machine-readable instructions for providing performance benchmarks for at least one medical practitioner, the machine-readable instructions comprising:
collecting clinical data from a plurality of medical practitioners, the clinical data pertaining to at least one clinical metric that relates to treatment offered to patients by the plurality of medical practitioners;
collecting business data from the plurality of medical practitioners, the business data pertaining to at least one business metric that relates to commercial performance of the plurality of medical practitioners;
preparing a plurality of benchmarking reports, the plurality of benchmarking reports comprising:
a first benchmarking report including a subset of the clinical data collected from the plurality of medical practitioners with respect to the at least one clinical metric, and
a second benchmarking report including a subset of the business data collected from the plurality of medical practitioners with respect to the at least one business metric, and
providing the first and second benchmarking reports to the at least one medical practitioner.

47. The processor readable medium of claim 46 wherein the at least one clinical metric comprises use of Beta blocker therapy for treatment of patients suffering from Left Ventricular Systolic Dysfunction, for treatment of patients eligible for Implantable Cardioverter-Defibrillator, or for treatment of post-Myocardial Infarction patients.

48. The processor readable medium of claim 46 wherein the at least one clinical metric comprises a metric that is selected from the group consisting of use of Aspirin post-Myocardial Infarction, use of ACE inhibitor/ARB for Congestive Heart Failure, use of Warfarin for Atrial Fibrillation, and use of Statins for Hypercholesterolemia.

49. The processor readable medium of claim 46 wherein the at least one clinical metric comprises a plurality of measures specified in predetermined treatment guidelines.

50. The processor readable medium of claim 46 wherein the at least one clinical metric comprises outcome measures or laboratory certifications items.

51. The processor readable medium of claim 46 wherein the at least one business metric comprises a metric that is selected from the group consisting of procedure volumes, encounters, E&M coding distribution, revenue, overhead, physician compensation structures, physician productivity, staffing, expenses, RVU production, account receivables, and profit.

52. The processor readable medium of claim 46 wherein the collecting the clinical data comprises accessing patient health records pertaining to the plurality of medical practitioners.

53. The processor readable medium of claim 46 wherein the collecting the clinical data comprises identifying patient charts pertaining to the plurality of medical practitioners based on a plurality of classification codes associating patient treatment with diagnoses.

54. The processor readable medium of claim 46 wherein the identifying the patient charts comprises using a statistically valid randomization process to select the charts for reviewing.

55. The processor readable medium of claim 46 wherein the collecting the clinical data comprises reviewing patient charts that are identified as having clinical data pertaining to the at least one clinical metric.

56. The processor readable medium of claim 55 wherein the reviewing the patient charts comprises determining whether a treatment relating to the at least one clinical metric was offered.

57. The processor readable medium of claim 56 wherein the reviewing the clinical data comprises recording an instance in which the treatment was not offered due to one or more contraindications.

58. The processor readable medium of claim 55 wherein the reviewing the patient charts comprises determining an amount of medication offered to treat a patient diagnosed with a particular medical condition relating to the at least one clinical metric.

59. The processor readable medium of claim 46 wherein the collecting the business data comprises:
accessing accounting records pertaining to the plurality of medical practitioners;
reviewing business records that are identified as having business data pertaining to the at least one business metric; and
recording business data pertaining to the at least one business metric.

60. The processor readable medium of claim 46 wherein at least one of the first and second benchmarking reports depicts a level of compliance of each one of the plurality of medical practitioners.

61. The processor readable medium of claim 46 wherein the first benchmarking report distinguishes instances in which treatment was not offered due to one or more contraindications.

62. The processor readable medium of claim 46 wherein at least one of the first and second benchmarking reports shows the at least one medical practitioner where the practitioner stands in comparison to the plurality of medical practitioners.

63. The processor readable medium of claim 46 wherein at least one of the first and second benchmarking reports shows the at least one medical practitioner where the practitioner stands in comparison to a plurality of medical practitioners within the practitioner's medical practice.

64. The processor readable medium of claim 46 wherein the machine-readable instructions further comprise:
collecting data related to additional factors from the plurality of medical practitioners;
preparing at least one other benchmarking report including a subset of the data collected from the plurality of medical practitioners with respect to the additional factors; and
providing the at least one other benchmarking report to the at least one medical practitioner.

65. The processor readable medium of claim 64 wherein the additional factors comprise outcome measures assessing economic or humanistic results of treatment for a particular disease or condition.

66. The processor readable medium of claim 64 wherein the additional factors comprise measures that are selected from the group consisting of satisfaction measures, use of disease management and regimen adherence programs, clinical quality assurance programs, benchmarking at discrete units of analysis, and use of evidence-based medicine practices.

67. The processor readable medium of claim 64 wherein the additional factors comprise measures obtained through distributing and collecting surveys that gauge responses to the first and second benchmarking reports.

68. The processor readable medium of claim 46 wherein the machine-readable instructions further comprise calculating a correlation between the subset of clinical data in the first benchmarking report and the subset of business data in the second benchmarking report.

69. The processor readable medium of claim 46 wherein the machine-readable instructions further comprise providing the calculated correlation to the at least one medical practitioner under certain conditions.

70. The processor readable medium of claim 46 wherein the machine-readable instructions further comprise providing the calculated correlation to the at least one medical practitioner if a substantially positive correlation is found between the subsets of clinical and business data.

71. The processor readable medium of claim 46 wherein the machine-readable instructions further comprise providing the at least one medical practitioner with at least one suggestion to improve the practitioner's performance.

72. The processor readable medium of claim 71 wherein the at least one suggestion comprises a suggestion that is selected from the group consisting of a recommendation to change treatment strategies, a recommendation to implement different organizational strategies, recommendations to streamline business operations and improve human performance, and a recommendation to collaborate with other medical practitioners to accelerate the speed at which changes occur.
